(19) United States
(12) Patent Application Publication
(10) Pub. No.: US 2012/0303324 A1
(43) Pub. Date: Nov. 29, 2012

(54) CONTROL SYSTEM FOR PROVIDING DIAGNOSTIC PULSE SIGNAL, AND CONTROL DEVICE THEREFOR

(75) Inventors: Hiroshi NAKATANI, Tokyo (JP); Yoshito SAMEDA, Kanagawa-ken (JP); Atsushi INOUE, Tokyo (JP); Naoya OHNISHI, Tokyo (JP); Makoto TOKO, Saitama-ken (JP)

(73) Assignee: KABUSHIKI KAISHA TOSHIBA, Tokyo (JP)

(21) Appl. No.: 13/477,321

(22) Filed: May 22, 2012

(30) Foreign Application Priority Data
May 23, 2011 (JP) 2011-115237

(51) Int. Cl. G06F 15/00

(52) U.S. Cl. 702/185; 702/183

(57) ABSTRACT

A control device includes a diagnostic pulse signal generating section having an internal circuit that generates control data and generates diagnostic pulse data for diagnosing the operating terminal and diagnoses the function of the signal line and the operating terminal from the waveform of a feedback signal of the diagnostic pulse signal; a variable amplification circuit that multiplexes the diagnostic pulse signal on the control signal and sends the result to the operating terminal with a preset signal level; and a receiving circuit that receives the feedback signal and sends it to the internal circuit. The internal circuit comprises a correction pulse data generating section that corrects the diagnostic pulse data by correcting the rise time of the diagnostic pulse signal. Even if the length of the signal line is long, the diagnostic pulse signal reception can be achieved without expanding the pulse width of the diagnostic pulse signal.

### CROSS-REFERENCE TO RELATED APPLICATION

This application claims benefit of priority from Japanese application number JP 2011-115237 filed May 23, 2011, the entire contents of which are incorporated by reference herein.

### FIELD

Embodiments of the present invention described herein relate generally to a control system for providing a diagnostic pulse signal and a control device therefor.

### BACKGROUND

As part of international standardization in recent years, the functional safety standard IEC61508 “Functional Safety of Electrical/Electronic/Programmable Electronic Safety-related Systems” has been established by the International Electrical Standardization Conference in respect of device manufacturers and suppliers. In addition, IEC61508 has been issued as a processing applications standard in respect of systems designers/integrators/users.

By means of such standards, safety in the life-cycle from system design and maintenance to final disposal can be evaluated and the safety integrity level (SIL), which is the required level for risk reduction, can be set as a quantitative evaluation standard.

The background to the foregoing is that, in order to raise the safety level of safety shutdown systems as a whole in for example industrial plants, it is demanded to perform not only fault diagnosis of the interior of the various devices such as the sensors, control devices (referred to in the Standard IEC61508 established by the International Electrical Standardization Conference, as “Logic Solvers”: referred to hereinafter as LS) and final elements (referred to in the Standard IEC61508 established by the international Electrical Standardization Conference, as “Final Elements”: referred to hereinafter as “operating terminals”) but also fault diagnosis including the signal lines connecting the control devices with the various devices.

Typically, sensors and operating terminals are not provided with an advanced diagnostic function, so a fault diagnostic function for signal lines between these control devices and sensors or operating terminals needs to be provided in the control device.

Incidentally, a technique is known in which a control device detects, as a diagnostic function of operating terminal devices, whether or not the signal from the operating terminal is received in the control device and whether or not the operating terminal delivers an output signal normally. An example is to be found in Japanese Patent Number 4131134 (hereinafter referred to as Patent Reference 1).

Also, as a function for diagnosis of the connection between the control device and the operating terminal, the technique is known of feeding back the signal line from the control device that is connected with the operating terminal once more to the control device, so as to detect whether or not the output signal from the control device has been correctly fed to the operating terminal. An example is to be found in Japanese Patent Number 3695234 (hereinafter referred to as Patent Reference 2).

In the systems of for example petrochemical plants, in some cases, the distance from the control device to the operating terminal may be a few hundred meters. In the case of such a long-distance transmission path, in Patent Reference 1 and Patent Reference 2 described above, there is the problem that the waveform of the diagnostic pulse signal is distorted by the delay components of the transmission path, with the result that it becomes impossible to detect normally the diagnostic pulse signal that is returned to the control device.

Also, although, in the aforementioned Patent Reference 1, inspection of the input path of the control device can be achieved, there is the problem that short-circuiting or disconnection of the signal line between the control device and the operating terminal cannot be detected.

Also, in the aforementioned Patent Reference 2, although short-circuiting of the signal line between the devices can be detected, there is the problem that, if the impedance of the signal line between the operating terminal and the device is smaller than the resistance value for current detection, short-circuiting of the signal line cannot be detected.

According to an aspect of the present technology, in a control device for diagnosing the connection between the signal line and an operating terminal by transmitting diagnostic pulse signal from the control device to the operating terminal, and a control system therefor: an object is to provide a control system and control device therefor whereby a diagnostic pulse signal can be accurately detected and whereby a diagnostic pulse signal is supplied that is capable of detecting short-circuiting or disconnection of the transmission path without affecting the impedance of a signal line that effects transmission over a long distance.

In order to achieve the above object, a control system according to the present embodiment for supplying diagnostic pulse signals comprises the following construction. Specifically:

A control system wherein a diagnostic pulse signal is transmitted through a signal line from a control device to an operating terminal and that diagnoses abnormality of the connection condition from aforementioned control device to aforementioned operating terminal and the function of this operating terminal, wherein aforementioned control system comprises aforementioned control device and aforementioned operating terminal, is characterized in that

aforementioned control device comprises a diagnostic pulse signal generating section provided with: an internal circuit that generates aforementioned control data that controls aforementioned operating terminal with a preset control period and generates diagnostic pulse data for diagnosing aforementioned operating terminal with a preset diagnostic period and diagnoses the connection condition from aforementioned control device to aforementioned operating terminal, based on the waveform of a feedback signal of the diagnostic pulse signal that is fed back from the input end of aforementioned operating terminal, and the function of aforementioned operating terminal; a variable amplification circuit provided with: a non-inverting amplification circuit that generates a control signal based on aforementioned control data; a DA converter that generates a diagnostic pulse signal based on aforementioned diagnostic pulse data; and an adder that multiplexes aforementioned diagnostic pulse signal on aforementioned control signal and delivers this to aforementioned operating terminal at a preset signal level; and

a receiving circuit that receives aforementioned feedback signal and delivers this to aforementioned internal circuit; aforementioned internal circuit further comprises a correction pulse data generating section that generates correction pulse data that corrects the rise time of aforementioned diagnostic pulse signal that is transmitted, and thereby corrects the diagnostic pulse data; and in that the rise time of aforementioned diagnostic pulse signal is corrected with reception of aforementioned diagnostic pulse signal being made possible by aforementioned operating terminal without expanding the pulse width of aforementioned diagnostic pulse signal, even when the length of aforementioned signal line is long.

In order to achieve the above object, a control device for a control system that supplies diagnostic pulse signals according to the present embodiment further comprises the following construction. Specifically,

a control system wherein a diagnostic pulse signal is transmitted through a signal line from a control device to an operating terminal and that diagnoses abnormality of the connection condition from aforementioned control device to aforementioned operating terminal and the function of aforementioned operating terminal is characterized in that aforementioned control device comprises a diagnostic pulse signal generating section provided with: an internal circuit that generates aforementioned control data that controls aforementioned operating terminal with a preset control period and generates diagnostic pulse data for diagnosing aforementioned operating terminal with a preset diagnostic period and diagnoses the connection condition from aforementioned control device to aforementioned operating terminal, based on the waveform of a feedback signal of the diagnostic pulse signal that is fed back from the input end of aforementioned operating terminal, and the function of aforementioned operating terminal; a variable amplification circuit provided with: a non-inverting amplification circuit that generates a control signal based on aforementioned control data; a DA converter that generates a diagnostic pulse signal based on aforementioned diagnostic pulse data; and an adder that multiplexes aforementioned diagnostic pulse signal on aforementioned control signal and delivers this to aforementioned operating terminal at a preset signal level; and a receiving circuit that receives aforementioned feedback signal and delivers this to aforementioned internal circuit; aforementioned internal circuit further comprises a correction pulse data generating section that generates correction pulse data that corrects the rise time of aforementioned diagnostic pulse signal that is transmitted, and thereby corrects the diagnostic pulse data; and wherein the rise time of aforementioned diagnostic pulse signal is corrected with reception of aforementioned diagnostic pulse signal being made possible by aforementioned operating terminal without expanding the pulse width of aforementioned diagnostic pulse signal, even when the length of aforementioned signal line is long.

### BRIEF DESCRIPTION OF THE DRAWINGS

FIG. 1 is a layout diagram of Embodiment 1;

FIG. 2 is a detailed layout diagram of Embodiment 1;

FIG. 3A and FIG. 5B are a time chart and waveform diagram to a larger scale showing the operation of the diagnostic pulse signal of Embodiment 1;

FIG. 4A, FIG. 4B and FIG. 4C are diagrams illustrating the problems relating to the diagnostic pulse signal of Embodiment 1: specifically, FIG. 4A being a pulse waveform diagram at the output terminal Po in a diagnostic pulse signal generating section;

FIG. 4B being a pulse waveform diagram at the input terminal Pi in a diagnostic pulse signal generating section; and

FIG. 4C being a view showing the RC components of the signal line;

FIG. 5A and FIG. 5B are views given in explanation of the principles of operation of Embodiment 1, specifically, FIG. 5A is a pulse waveform diagram at the output terminal Po of the diagnostic pulse signal generating section and FIG. 5B is a pulse waveform diagram at the input terminal Pi of the diagnostic pulse signal generating section;

FIG. 6 is a layout diagram of Embodiment 2;

FIG. 7 is a modification of Embodiment 2; and

FIG. 8A, FIG. 8B1, FIG. 8B2, FIG. 8B3 are views given in explanation of the construction and operation of Embodiment 3;

FIG. 9A and FIG. 9B are views given in explanation of the construction and operation of Embodiment 4; and

FIG. 10A and FIG. 10B are views given in explanation of the construction and operation of Embodiment 5.

### DETAILED DESCRIPTION

Embodiments of the present invention are described below with reference to the drawings.

### Embodiment 1

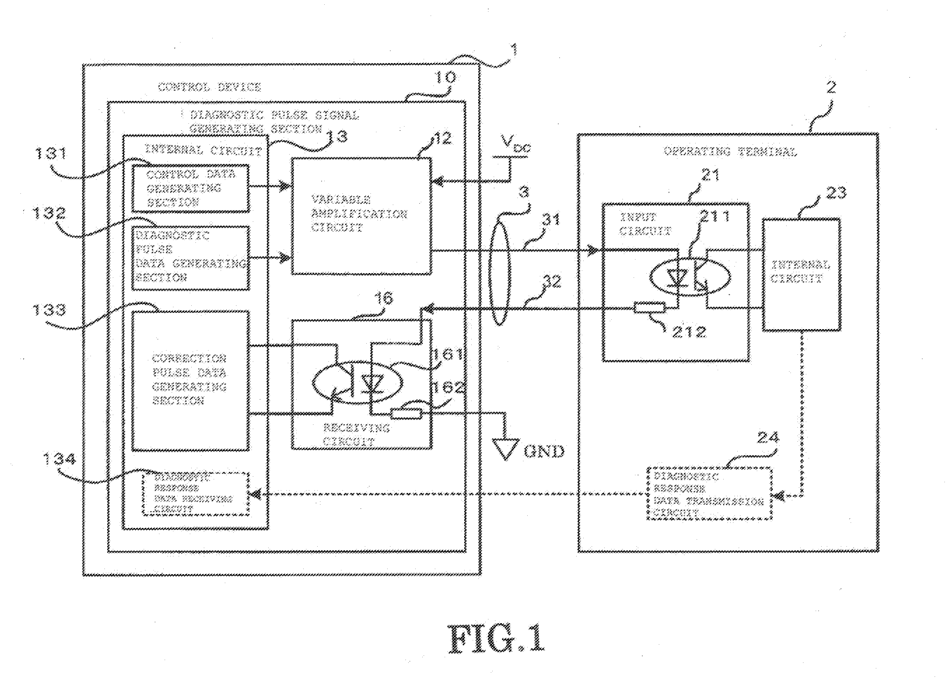

Embodiment 1 is described below with reference to FIG. 1 to FIG. 5 and FIG. 5B. First of all, the layout will be described with reference to FIG. 1.

The control system of the present embodiment comprises: a control device 1 that controls an operating terminal 2; an operating terminal 2 that is controlled by a control signal from the control device 1; and a signal line 3 that supplies a diagnostic pulse signal multiplexed with the control signal from the control device 1 to the operating terminal 2.

The control device 1 comprises a diagnostic pulse signal generating section 10 for diagnosing the function of the operating terminal 2: this diagnostic pulse signal generating section 10 comprises an internal circuit 13 that generates control data of the control signal that is used to control the operating terminal 2 and diagnostic pulse data that generates an output signal matching the received signal level of the operating terminal 2 by multiplexing the diagnostic pulse data with the control data generated by the internal circuit 13; a variable amplifier circuit 12; and a receiving circuit 16 that receives a feedback signal whereby the output signal that is sent from this variable amplifier circuit 12 is fed back from the input terminal of the operating terminal 2.

The operating terminal 2 is a device such as for example a valve and comprises an input circuit 21 that receives the control signal from the control device 1 through the signal line 3, and an internal circuit 23 that controls the operating terminal 2 itself and is responsive to the signal received by the input circuit 21.

In general, in regard to the diagnostic pulse signal, when diagnosing the function of the signal line 3 to its input circuit 21, this is processed by the feedback signal from the input terminal of the input circuit 21: when diagnosing the function of the internal circuit 23, as shown by the broken line, a diagnostic response data transmission circuit 24 is provided in the operating terminal 2 and a diagnostic response data receiving circuit 134 is provided in the control device 1 and the control device 1 diagnoses whether the diagnostic response data that is sent from the internal circuit 23 is satisfactory or not.

Also, the diagnostic pulse signal is output multiplexed with the bits used to output the control signal on the signal line 3. The mode of this diagnostic pulse signal output may be either parallel output or serial output. Various forms may also be adopted for the circuit used for output of the diagnostic pulse signal, depending on the transmission distance to the operating terminal 2 and the type of insulation. The mode of output of a single bit in this embodiment is as shown in the drawings.

Next, the various sections are described in detail. The internal circuit 13 comprises: a control data generating section 131 that generates control data for controlling the operating terminal 2 with a preset control period Tc; a diagnostic pulse data generating section 132 that generates diagnostic pulse data, for diagnosing the operating terminal 2, with a diagnostic period Td that is different from the preset control period, being longer than the control period; and a correction pulse data generating section 133 that corrects the diagnostic pulse signal from the waveform of the feedback signal that is fed back from the input, terminal of the operating terminal 2 and generates correction pulse data for correcting the rise time of the diagnostic pulse signal.

Also, the internal circuit 13 comprises a computational processor, not shown, and is provided with a diagnostic function for diagnosing abnormality of the connection condition of the control device 1 and the operating terminal 2 and/or the satisfactoriness of the operating condition of the operating terminal 2, from the diagnostic pulse signal that is fed back (i.e. the feedback signal).

Furthermore, in more detail, the correction pulse data generating section 133 generates correction pulse data that corrects the rise time and fall time of the transmitted diagnostic pulse signal; the internal circuit 13 uses this correction pulse data to correct the diagnostic pulse data and corrects the rise time of the diagnostic pulse signal, so as to make it possible for the operating section terminal 2 to receive the diagnostic pulse signal without expansion of the pulse width of the diagnostic pulse signal, even if the signal line 3 comprises a long-distance transmission path.

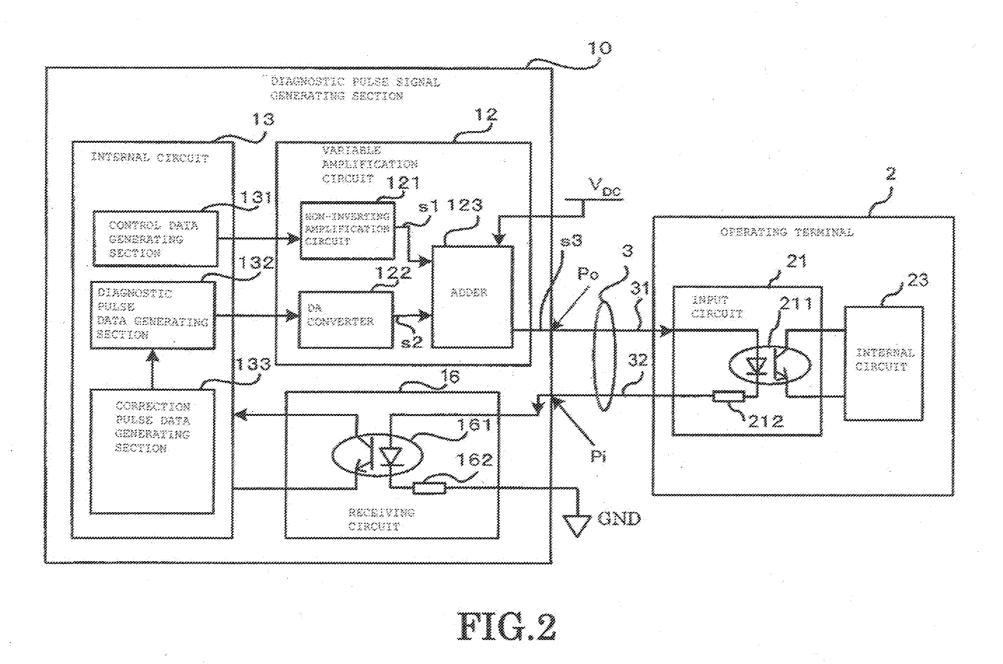

Also, as shown in FIG. 2, the variable amplifier circuit 12 comprises: a non-inverting amplifier circuit (non-inverting amplifier) 121 that generates a control signal based on the control data; a DA converter 122 that generates a diagnostic pulse signal based on the diagnostic pulse data; and an adder 123 supplied with power source voltage Vₓ from an isolated external power source, that multiplexes the diagnostic pulse signal with the control signal, and outputs the result as signal level matching the operating terminal 2. A DA converter means a converter that converts from a digital signal to an analogue signal.

Also, the receiving circuit 16 employs a photocoupler 161 to provide isolation from the interior of the control device 1; the primary-side anode of the photodiode is connected with a signal line 32 providing a feedback route for the feedback signal from the operating terminal 2, while the cathode of the photodiode is connected with external ground potential GND through a current-limiting resistance 162, and detects the voltage level of the feedback signal.

Also, the input circuit 21 of the operating terminal 2 comprises a photocoupler for providing isolation from the interior of the operating terminal 2, and a preset current-limiting resistance 212; the anode of the photocoupler 211 is connected with a signal line 31 on one side, while the other side thereof is connected with another signal line 32, through a load resistance 212.

In this embodiment, the interface was illustrated for the case where the control device 1 and operating terminal 2 are isolated by a photocoupler; however, various other modes of interfacing could be adopted, using for example insertion of a current limiting resistance 212 in parallel with the input circuit 211 between the signal line 31 and 32, series connection of the signal line 31 with the anode of the photocoupler 211, or the transmission distance between the signal line and input circuit of the operating terminal 2.

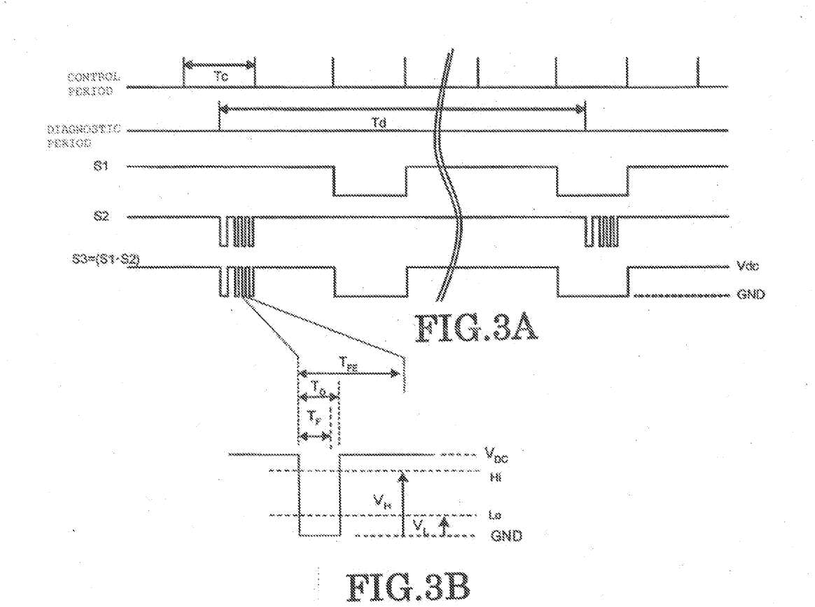

Next, the operation of a diagnostic pulse generation section 10 constructed in this way will be described with reference to FIG. 2 and FIG. 3A.

In the internal circuit 3, as shown in FIG. 3A, after a request for control performance by the control device 1, the control data is updated with a preset control period Tc, for example 1 msec, and the diagnostic pulse data is updated with the preset, comparatively slow, diagnostic period Td, for example 1 sec: a control signal s1 based on the control data that is thus obtained is input from the non-inverting amplification circuit 121, and a diagnostic pulse signal s2 based on the diagnostic pulse data is input from the DA converter 122 to the adder 123, respectively.

The non-inverting amplification circuit 121 generates a control signal corresponding to the control data output from the control data generating section 131: in order to confer freedom regarding the output, this circuit may also be constituted by a DA converter.

The adder 123 combines these signals: for example, it finds the logical product of the control signal s1 and the diagnostic pulse signal s2 and outputs this logical product, as a signal matching the reception potential level of the operating terminal 2, using as references the ground signal GND that is earthed through the receiving circuit 16 and the external potential V_{DC} supplied to the variable amplification circuit 12.

Ideally, the single pulse of the diagnostic pulse signal s3 that is generated by the variable amplification circuit 12 has a waveform as shown in FIG. 3B.

Now according to the ISA (American Measurement Instrument Industrial Association) Standard, which issues a safety standard for safety instrumentation systems of chemical process industries, the output signal of a safety shutdown system should be Hi level (in the case of the valve of the operating terminal 2, this means that the risk side operating signal should be “valve open”) during ordinary control and should become Lo level (in the case of the valve of the operating terminal 2, this means that the safe side operating signal should be “valve closed”) in the case of shutdown. This represents the “fail safe” concept.

The test of the operating terminal 2 is conducted in a condition with the control device 1 performing ordinary control: the output signal is therefore ordinarily Hi level.

A diagnostic pulse signal is therefore periodically output, in order to confirm that the control device 1 is capable of outputting Lo level when needed. The diagnostic pulse signal for confirming the Lo level output function is a Lo level pulse signal as shown in FIG. 3B.

Also, in order to avoid spurious detection by the receiving circuit 16, the La level of the diagnostic pulse signal is less than the Lo level detectable maximum potential V_{L} of the receiving circuit 16. Also, in order to avoid spurious detection by the receiving circuit 16, the Hi level of the diagnostic pulse signal is also at least the Hi level detectable minimum potential V_{H} of the receiving circuit 16.

Also, in order to avoid spurious operation of the operating terminal 2, the pulse width T₀ of the diagnostic pulse signal is set to be shorter than the maximum insensitive time width T_{FE} of the operating terminal 2.

Thus, the variable amplification circuit 12 of the control device 1 multiplexes the diagnostic pulse signal that is output from the internal circuit 13 with the control signal and outputs the result as a signal of pulse waveform as described above.

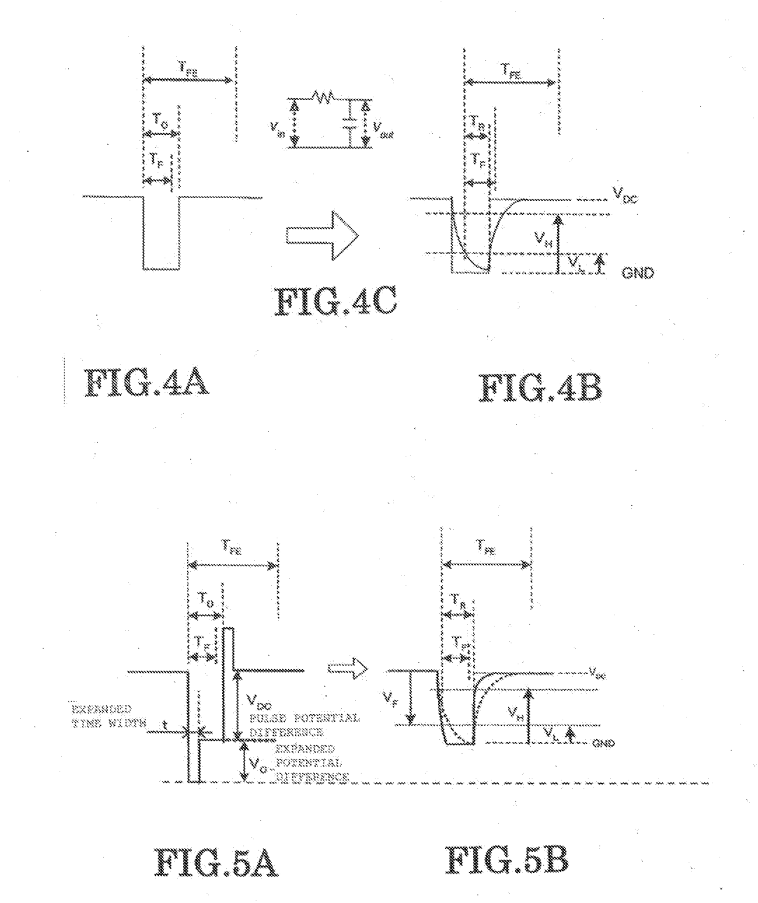

However, in the application of an actual safety shutdown system, in some cases, the distance from the control device 1 to the operating terminal 2 may be a few hundred meters. In such cases, as shown in FIG. 4A, if a single pulse signal is output from the control device 1, the pulse waveform of the pulse signal changes due to the delay component (RC) of a long-distance signal line 3 as shown in FIG. 4C, with the result that the pulse waveform that is fed back to the receiving circuit 16 of the control device 1 may be a distorted waveform as shown in FIG. 4B.

As shown in FIG. 4A and FIG. 4B, due to the distortion produced by the delay component of the signal line 3 at the receiving circuit 16 of the control device 1, the effective pulse width T_{R} (pulse time width that is detected as “Lo level” by the control device 1) of the output pulse width T₀ of the diagnostic pulse signal may in fact undershoot the minimum detection time width T_{F} of the control device 1.

In this case, the control device 1 may be incapable of detecting the pulse that is output on the control line 31 at the receiving circuit 16.

One method of dealing with this problem is to expand the time width of the output pulse width T₀. However, if the pulse width is too long, the output pulse width T₀ may exceed the maximum insensitive time width T_{FE} of the operating terminal 2, with the result that the diagnostic pulse signal may cause spurious operation (such as for example valve closure) of the operating terminal 2.

In order to solve this problem, as shown in FIG. 1A, the diagnostic pulse generating section 10 of the control device 1 of this Embodiment 1 is provided with a function of outputting a pulse wherein the rising edge voltage of the pulse waveform of the diagnostic pulse signal is elevated. (Hereinafter, the two waveforms, namely, the rising edge and the trailing edge of the pulse waveform will both be referred to as “rising edge”).

FIG. 5A shows the pulse waveform at the output terminal do of the control device 1; FIG. 5B shows the pulse waveform of the diagnostic pulse signal at the input terminal Pi of the control device 1.

Specifically, the potential difference at the rising edge of the pulse waveform that is output from the variable amplification circuit 12 of the control device 1 is expanded for a fixed time is as shown in FIG. 5A whereas the response waveform was conventionally as indicated by the broken line: thus the rise time is speeded up as shown in FIG. 5B by this expansion of the potential difference. In other words, the rise becomes steep.

In this way, the pulse signal received by the control device 1 can be made detectable by excluding the possibility of the effective pulse width T_{R} undershooting the maximum length detection time width T_{FE} of the control device 1, yet without expanding the pulse width.

The reason for this that, by performing correction to expand the potential difference of the pulse waveform of voltage change, the time taken for this corrected pulse signal to reach a potential at which reception can take place is shortened.

Next, the principles of generation of the pulse waveform of this diagnostic pulse signal will be explained. In order to make the pulse signal that is received by the receiving circuit 16 of the control device 1 capable of detection, the internal circuit 133 generates corrected pulse data such as to satisfy the following expressions (1) and (2) in respect of the expanded potential difference Vo and the expanded time width t of the pulse wave form shown in FIG. 5A; this correction is then performed by the diagnostic pulse data generating section 132 and this corrected diagnostic pulse signal is then output from the variable amplification circuit 12.

Specifically, the expanded potential difference V_{O}(V) and the expanded time width t(s) of the diagnostic pulse signal are given by values in the range defined by the following expressions:

V_{F}≦(V_{O}+V_{DC})(1−e^{-t/CR}) (1)

T_{O}−T_{F}≧t (2)

where

V_{DC} is the pulse potential difference (V);

V_{F} is the minimum potential difference (V) that is capable of detection (by the control device);

e is the base of natural logarithms (2.71828 . . . );

C is the capacitative component (F) of the signal line and R is the resistive component (Ω) of the signal line;

T₀ the output pulse width (s) (at the output terminal P_{O} of the control device);

T_{F} is the minimum detection time width (s) (at the input terminal P_{I} of the control device).

Hereinafter, the derivation of expressions (1) and (2) will be described. In general, taking the equivalent circuit of the signal line 3 as being a first-order delay (PC) circuit, as shown in FIG. 4C, there is the following relationship between the input potential difference Vin of the RC circuit and the output voltage Vout of the capacitative component C:

Vout≦Vin·(1−e^{-t/CR}) (3)

where Vout must exceed the minimum potential difference V_{F} that is capable of being detected. (4)

Also,

Vin=Vo(expanded potential difference)+V_{DC}(pulse potential difference) (5)

Consequently, expression (1) can be found from expression (3), condition (4) and expression (5).

Also, in order to prevent spurious operation (such as for example valve closure) of the operating terminal 2 by the diagnostic pulse signal, it is necessary that the effective pulse width T_{R} at the input terminal P_{I} of the control device 1 should be shorter than the maximum-length detection time width T_{FE}.

Also, the value of the expanded time width t is defined by expression (2).

It should be noted that, in FIG. 5A and FIG. 5B, the corrected pulse data could be either of the expanded potential difference×expanded time (V_{O}×t), or (expanded potential difference+pulse potential difference)×expanded time ((V_{O}+V_{DC})×t).

Thus, with the above embodiment, the rise time of the pulse waveform can be corrected without expanding the pulse time width of the diagnostic pulse signal, so, even in the case of a long-distance transmission path having a delay circuit characteristic such that the pulse waveform of the diagnostic pulse signal is distorted, the presence of abnormality in the control signal can be accurately diagnosed from the feedback signal.

### Embodiment 2

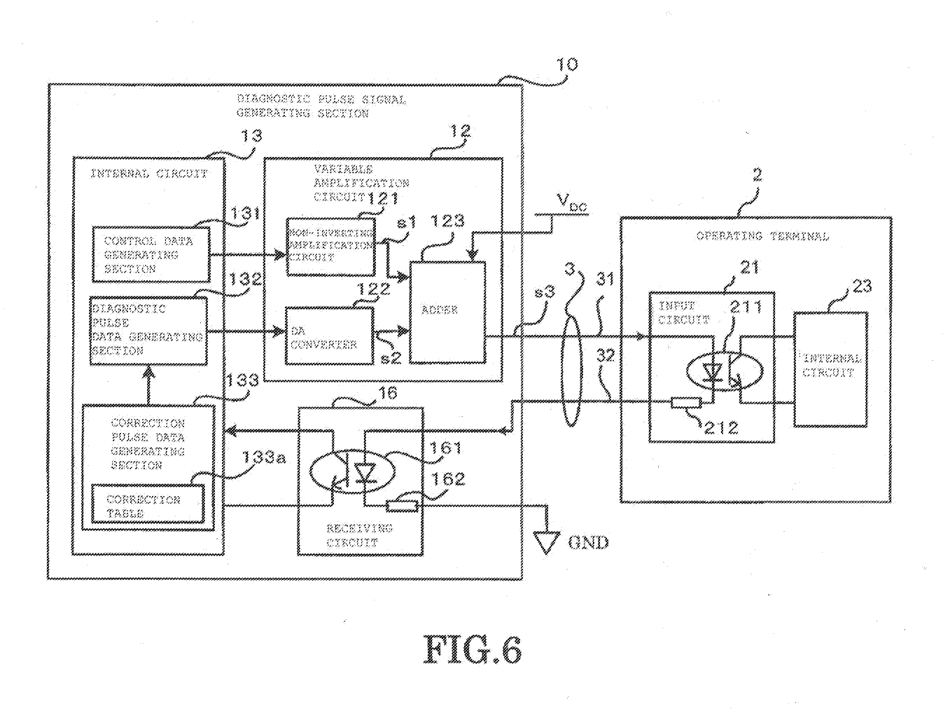

Embodiment 2 will now be described with reference to FIG. 6. Of the various parts of Embodiment 2, parts that are identical with those of the control system of Embodiment 1 are given the same reference symbols and further description is dispensed with.

The aspect in which the control system of Embodiment 2 differs from Embodiment 1 is that, whereas, in Embodiment 1, no function for automatically generating correction pulse data was provided; in the case of Embodiment 2, a correction table 133a is provided in the correction pulse data generating section 133: the rise time of the pulse waveform and this pulse width are detected from the feedback signal and the correction pulse data corresponding to the characteristics of this rising waveform are found beforehand; thus, even if the transmission path length (transmission path characteristic or impedance×distance) to the operating terminal 2 changes, correction pulse data (expanded potential difference×expanded time) can be automatically generated by referring to the correction table 133a.

Thus, with this construction according to Embodiment 2, diagnostic pulse data can be generated that is automatically corrected even if the characteristics of the input circuit or transmission path of the operating terminal 2 change.

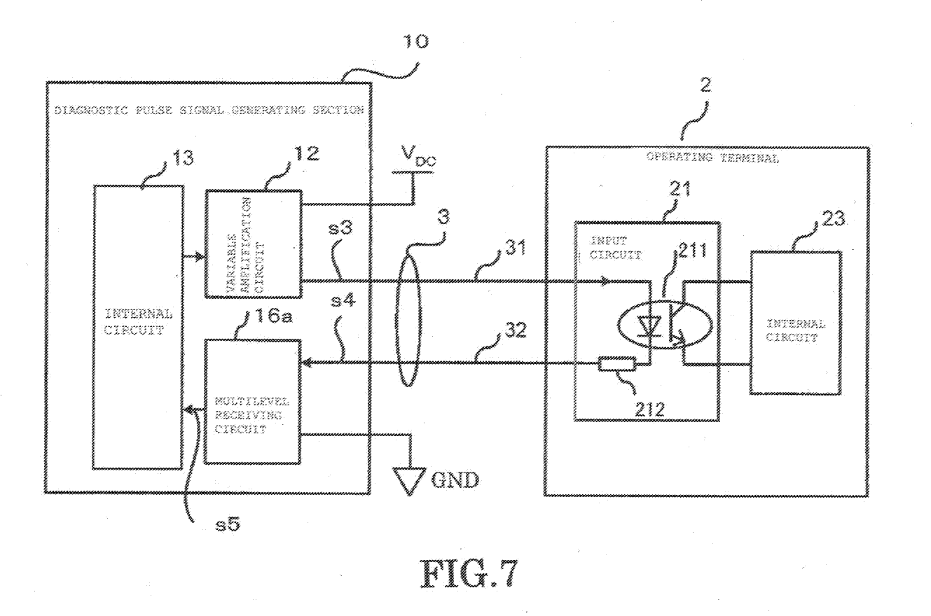

Also, as shown in FIG. 7, the input circuit 16 is modified to constitute a multilevel receiving circuit 16a capable of decomposing the signal level of the feedback signal into multiple levels; a correction table 133a is provided that stores beforehand in correspondence the output of this multilevel receiving circuit 16a and the appropriate correction pulse data: correction can then be automatically effected by identifying the level of the feedback signal and retrieving the corresponding value in the correction table 133a.

### Embodiment 3

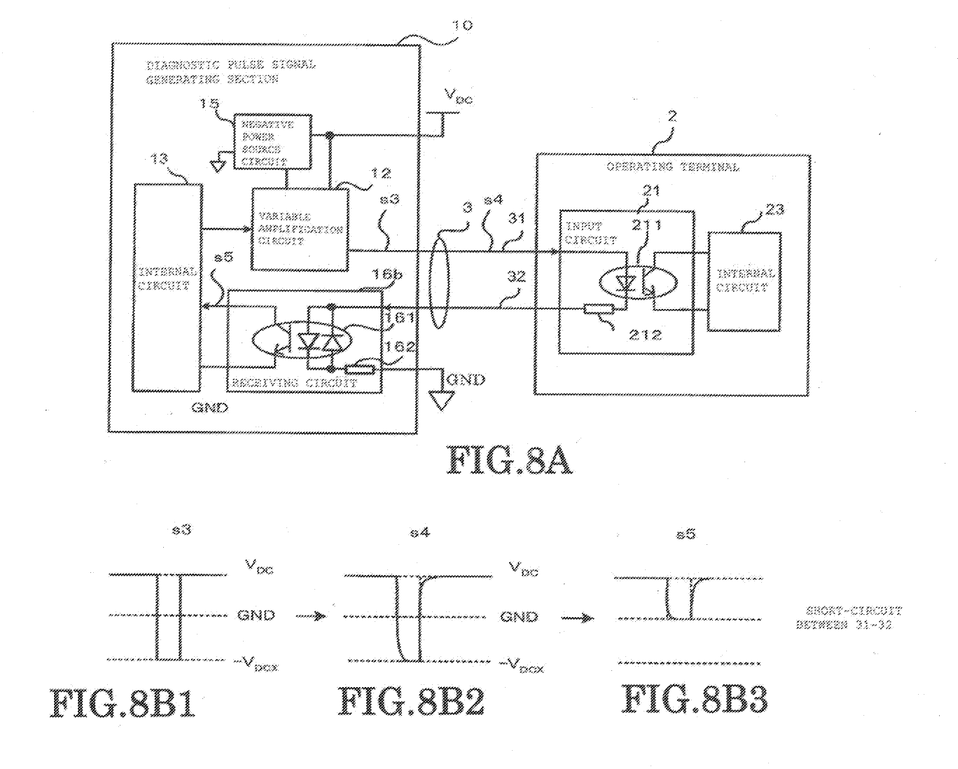

Embodiment 3 will now be described with reference to FIG. 8A, FIG. 8B1, FIG. 8B2 and FIG. 8B3. Of the various parts of Embodiment 3, parts that are identical with those of the control system of Embodiment 1 are given the same reference symbols and further description is dispensed with.

The aspect in which the control system of Embodiment 3 differs from Embodiment 1 is that, whereas, in Embodiment 1, no function for determining the satisfactoriness of the transmission path of the diagnostic pulse signal was provided, in the case of Embodiment 3, it is arranged to detect short-circuiting of the signal line 3 using the diagnostic pulse signal.

With the control device 1 of Embodiment 3, in addition to the construction of Embodiment 1, there are provided a negative power source circuit 15 shown in FIG. 8 and, instead of the receiving circuit 16, a receiving circuit 16b further comprising a photodiode on the input side of a photocoupler and a diode of inverse polarity connected in parallel therewith, forming a return circuit through which the feedback signal flows in both directions.

In FIG. 8A, the negative power source circuit 15 is a circuit that generates a negative voltage −V_{DCX} of negative potential from the power source V_{DC} and GND, taking the ground potential END as 0 V: the negative voltage −V_{DCX} that is thus generated is input to the variable amplification circuit 12.

The receiving circuit 16b is a circuit that makes possible passage of current even if the voltage of the signal line 32 and the ground potential GND is the negative voltage −V_{DCX}.

The variable amplification circuit 12 of Embodiment 3 generates a pulse waveform as shown in FIG. 8B1 from the negative voltage −V_{DCX} that is supplied from the power source V_{DC} and the negative power source circuit 15.

The control device 1 of Embodiment 3 constructed in this way can detect short-circuit faults of the signal line 31 and signal line 32. The operation of such short-circuit detection will now be described.

When a short-circuit fault is generated across the transmission lines 3, the diagnostic pulse signal that is generated by the variable amplification circuit 12 passes through the input circuit 21, constituting a pulse signal that flows along the path, in this order: variable amplification circuit 12→signal line 31→signal line 32→receiving circuit 16b. At: this point, when the output waveform constituted by the negative voltage from the output terminal s3 of the variable amplifier 12 is applied as in FIG. 8B1, a pulse current flows in the opposite direction and the output s5 on the secondary side of the receiving circuit 16b produces the half-wave rectified output respectively shown in FIG. 8B2 and FIG. 8B3.

On the other hand, if no short-circuit fault occurs i.e. operation is normal, on a negative voltage pulse, inverse voltage is applied in the reverse direction to the receiving circuit 21 of the operating terminal 2: consequently, due to the rectifying function of the photodiode of the photocoupler 211, no signal current can flow in the signal line 31 or signal line

The output terminal s3 of the variable amplifier 12 and the output s5 of the secondary side of the receiving circuit then respectively become high-impedance and are fixed at the potential of the respective terminals.

Consequently, if, for a negative voltage pulse, the diagnostic pulse signal, which ought not to be detectable in normal operation, in fact detected by the receiving circuit 16, in other words, if there is a signal line short-circuit or a fault of some kind, passage of this pulse by the receiving circuit 21 of the operating terminal 2 can be identified by the control device 1.

As described above, with this embodiment, it becomes possible for the control device to detect short-circuit faults of the signal line connecting the control device and the operating terminal, irrespective of the impedance of the signal line path: the fault detect Lou function of the safety shutdown system can thus be improved.

### Embodiment 4

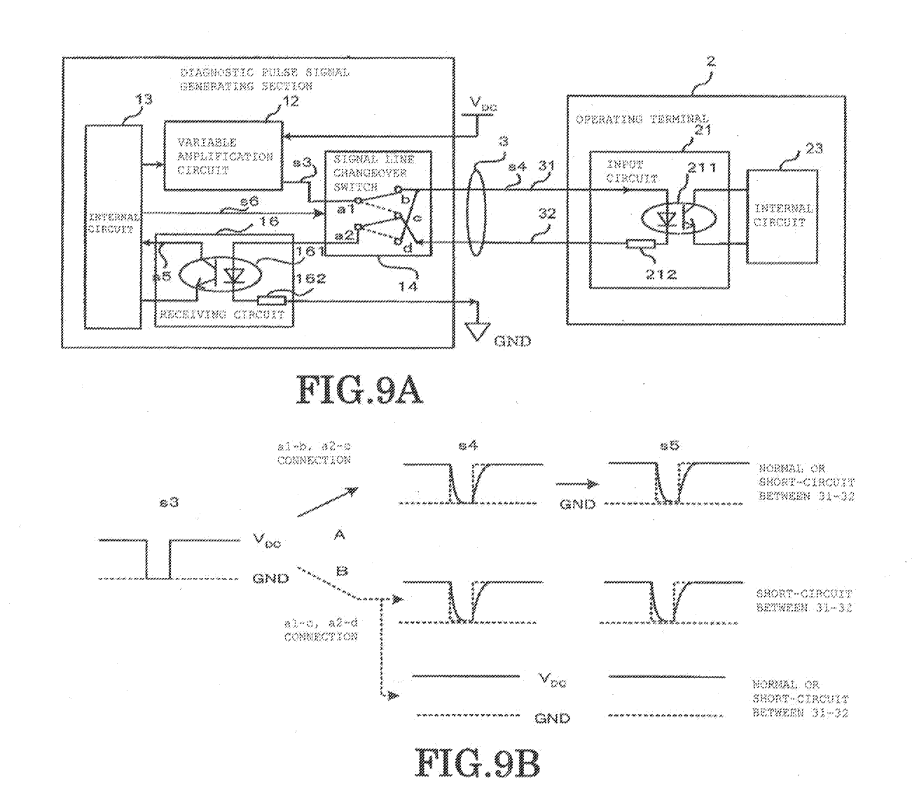

Embodiment 4 will now be described with reference to FIG. 9A and FIG. 9E. Of the various parts of Embodiment 4, parts that are identical with those of the control system of Embodiment 1 are given the same reference symbols and further description is dispensed with.

The aspect in which the control system of Embodiment 4 differs from Embodiment 1 is that, whereas, in Embodiment 1, no function for determining the satisfactoriness of the transmission path of the diagnostic pulse signal was provided, in the case of Embodiment 4, it is arranged to detect short-circuiting of the signal line 3 using the diagnostic pulse signal.

In the case of the control device 1 of Embodiment 4, there is provided a signal line changeover switch 14 that connects the diagnostic pulse signal that is applied to the operating terminal 2 from the variable amplification circuit 12 of Embodiment 1 with the signal line 31 or signal line 32 and that connects the receiving circuit 16 with the signal line 32 or signal line 31.

In regard to this changeover, although not shown, a construction could be adopted so as to output a changeover instruction s6 in respect of the signal changeover switch 14 from a diagnostic pulse data generating section 132 of the internal circuit 13.

The signal line changeover switch 14 is a switch that changes over the direction of application of the diagnostic pulse signal in respect of the input circuit 21 by changing over the connection to the signal line 3 that is connected between the output terminal of the variable amplification circuit 12 and the input terminal of the receiving circuit 16, at the output terminal in question and the input terminal in question.

In more detail, the direction of application of the output of the variable amplifier 12 to the operating terminal 2 is changed over by connecting the output s3 of the variable amplification circuit 12 to a first path (signal line 31 from the signal line changeover switch a1-b, signal line changeover switch c-a2 from the signal line 32, indicated by the solid line) or by connecting it to a second path (signal line 32 from the signal line changeover switch a1-c, signal line changeover switch d-a2 from the signal line 31, indicated by the broken line).

The control device 1 of Embodiment 4 constructed as above can detect short-circuit faults of the signal line 31 and signal line 32. This detection operation is described below.

If the signal line changeover switch 14 is connected with the first path and a short-circuit fault occurs on the signal line 31 and signal line 32, even if a diagnostic pulse signal is applied by the control device 1, the short-circuit fault cannot be detected.

The reason for this is that, in the case of the first path, if a short-circuit fault occurs, the change with respect to the normal situation is only of an extent such as to pass the receiving circuit 21: thus no marked change occurs in the diagnostic pulse signal.

In contrast, in the case where the signal line changeover switch 14 is connected with the second path, the control device 1 can detect a short-circuit fault.

In the event of a short-circuit fault, the diagnostic pulse signal passes through the input circuit 21 and flows by the path: variable amplification circuit 12→signal line 32→signal line 31→receiving circuit 16. In these circumstances, if there is no short-circuit fault, while the signal line changeover switch 14 is on the second path, inverse voltage is applied to the input circuit 21 of the operating terminal 2, so no signal current can flow to the signal line 31 or signal line 32, due to the rectifying function of the photodiode.

Consequently, if the signal line changeover switch 14 is connected with the second path, if the diagnostic pulse signal, which ought not to be detected during normal operation, is in fact detected by the receiving circuit 16 i.e. if the input circuit 21 of the operating terminal 2 is bypassed due to short-circuiting of the signal line or a fault of some kind, this fact can be identified by the control device 1.

As described above, with this embodiment, it becomes possible for the control device to detect a short-circuiting fault of the signal line that links the control device and the operating terminal, irrespective of the impedance of the signal path: the fault detection function of the safety shutdown system can thus be improved.

### Embodiment 5

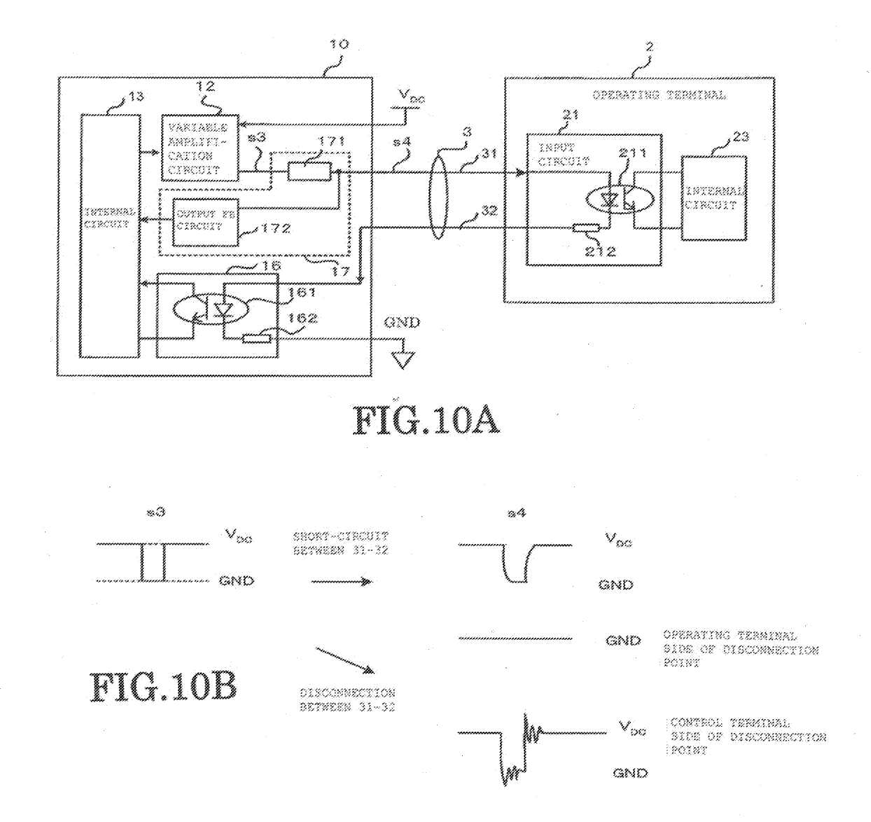

Embodiment 5 will now be described with reference to FIG. 10A and FIG. 10B. Of the various parts of Embodiment 5, parts that are identical with those of the control system of Embodiment 1 are given the same reference symbols and further description is dispensed with.

The aspect in which the control system of Embodiment 5 differs from Embodiment 1 is that, whereas, in Embodiment 1, no function for determining the satisfactoriness of the transmission path of the diagnostic pulse signal was provided, in the case of Embodiment 5, it is arranged to detect short-circuiting or disconnection of the signal line 3 using the diagnostic pulse signal.

In the control device 1 of Embodiment 5, in addition to the construction of Embodiment 1, an impedance matching circuit (variable matching resistance) 171 is provided inserted in parallel between an output feedback circuit 172 that directly receives the output from the variable application circuit 12 to the signal line 31 in the interior of the control device 1 and the variable amplification circuit 12 and signal line 31.

The output feedback circuit 172 detects the potential level of the input signal and is provided with a function of reporting this detection result to the internal circuit 13; this output feedback circuit 172 provides high input impedance in respect of the input signal of the variable amplification circuit 12 via the impedance matching circuit 171.

The impedance matching circuit 171 is a series resistance of variable resistance value: this impedance matching circuit 171 is provided with a function of matching the characteristic impedance regarding the signal line 31, input circuit 21 and signal line 32 as a single cable, and the impedance of the impedance matching circuit 171 itself.

The control device 1 of Embodiment 5 constructed in this way is capable of detecting short-circuit faults of the signal line 31 and signal line 32 and disconnection faults of the signal line 31. The detection action will be described below.

The electrical signal that is transmitted along the signal line 3 has the properties of a wave and reflection can occur at the terminal of the transmission, line or location of cable connection. However, even if cables of different kinds are connected, no reflection takes place if their characteristic impedances are equal (this is called impedance matching). However, if the characteristic impedances of the different types of cable are different, part of the signal is transmitted at the reflection point, while the remainder is reflected.

However, at the point of connection of the signal line 31 and the one end of the outlet signal line of the impedance matching circuit 171, once the impedances have been matched, matching is performed so that the characteristic impedances of both lines coincide: reflection therefore does not occur.

However, in the event of a short-circuit fault of the signal line 31 and signal line 32, when there is a change in the characteristic impedance, regarding the signal line 31, input circuit 21 and signal line 32 as a single cable, the characteristic impedance of the two lines becomes different at the connection point of the signal line 31 and the one end of the outlet signal line of the impedance-matched impedance matching circuit 171 prior to short-circuiting: thus reflection of the signal takes place.

Because of superimposition of this reflected wave and the output pulse wave of the diagnostic pulse signal, the pulse waveform of the diagnostic pulse signal at the connection point is distorted. The waveform of a diagnostic pulse signal that is different from that obtained under normal conditions is detected by the output feedback circuit 172.

Also, in the case of a disconnection fault of the signal line 31 or signal line 32, total reflection of the signal waveform takes place at the disconnected portion, so, due to superimposition of the totally reflected wave and the output pulse wave as in the case of a short-circuiting fault, the pulse waveform of the diagnostic pulse signal at the connection point is considerably distorted.

This distorted pulse waveform is input to the output feedback circuit 172, sc that a diagnostic pulse signal waveform different from that obtained under normal conditions is detected by the output feedback circuit 172. In this way, the control device 1 can detect occurrence of any abnormality, including a disconnection fault, on the signal line 31 and signal lines beyond this.

As described above, with this embodiment, it becomes possible for the control device to detect short-circuit faults or disconnection faults of the signal line connecting the control device and the operating terminal: the fault detection function of the safety shutdown system can thus be improved.

While various embodiments of the present invention have been described above, these embodiments are presented merely by way of example and are not intended to restrict the scope of the invention. Novel embodiments could be implemented in various other ways and various deletions, substitutions or alterations could be made within a range not departing from the gist of the invention. Such embodiments or modifications are included in the scope or gist of the present invention and are included in the scope of equivalents of the present invention as set out in the patent claims.

What is claimed is:

1. A control system wherein a diagnostic pulse signal is transmitted through a signal line from a control device to an operating terminal and that diagnoses abnormality of a connection condition from said control device to said operating terminal and a function of said operating terminal,
wherein said control system comprises, said control device and said operating terminal,
and, further, said control device comprises a diagnostic pulse signal generating section provided with:
(1) an internal circuit that generates control data that controls said operating terminal with a preset control period and generates diagnostic pulse data for diagnosing said operating terminal with a preset diagnostic period and diagnoses a connection condition from said control device to said operating terminal, based on a waveform of a feedback signal of said diagnostic pulse signal that is fed back from an input end of said operating terminal, and said function of said operating terminal;
(2) a variable amplification circuit, provided with:
(a) a non-inverting amplification circuit, that generates a control signal based an said control data;
(b) a DA converter that generates a diagnostic pulse signal based on said diagnostic pulse data; and
(c) an adder that superimposes said diagnostic pulse signal on said control signal and delivers this to said operating terminal at a preset signal level; and
(3) a receiving circuit that receives said feedback signal and delivers this to said internal circuit,
wherein said internal circuit further comprises a correction pulse data generating section that generates correction pulse data that corrects a rise time of said diagnostic pulse signal that is transmitted, and thereby corrects said diagnostic pulse data; and
wherein said rise time of said diagnostic pulse signal is corrected and a diagnostic pulse signal is supplied with reception of said diagnostic pulse signal being made possible by said operating terminal without expanding a pulse width of said diagnostic pulse signal, even when a length of said signal line is long.

2. The control system with a diagnostic pulse signal according to claim 1,
wherein said internal circuit receives said feedback signal and measures said rise time and said pulse width of said diagnostic pulse signal that is transmitted and comprises a correction table in which there are arranged in correspondence beforehand said pulse width of a measurement value in question and said corrected pulse data and a pulse crest value thereof; and
said diagnostic pulse data is automatically corrected using said measured value of said feedback signal by referencing said correction table.

3. The control system with a diagnostic pulse signal according to claim 1,
wherein said receiving circuit is a receiving circuit capable of detecting multiple potential levels; and
said internal circuit receives said potential level and comprises a correction table in which there are arranged in correspondence beforehand said potential level, said pulse width of said corrected pulse data and said pulse crest value thereof; and
said diagnostic pulse data is automatically corrected using said measured value of said feedback signal by referencing said correction table.

4. The control system with a diagnostic pulse signal according to claim 1,
wherein an input circuit of said operating terminal and said receiving circuit of said control device are respectively constituted by photocoupler isolating circuits, and
said input circuit is constituted by connecting a primary side thereof in series a diode of a photocoupler and a current limiting resistance thereof, one end thereof being connected through said signal line with an output of said variable amplification circuit, while another end thereof is connected through said signal line with an input terminal of said receiving circuit;
said receiving circuit is constituted by a first diode, a terminal that is connected with an anode of said first diode of said photocoupler constituting one end of said feedback signal from said input circuit, while said terminal that is connected with ground potential of said photocoupler isolating circuit constitutes another end of a cathode of said first diode, and, in addition, a second diode that is connected with inverse polarity to said first diode;
said diagnostic pulse signal generating section is further provided with a negative power source circuit that provides negative potential on a low potential side of said diagnostic pulse signal of said variable amplifier, and
said internal circuit is arranged so as to conclude “short-circuit is present” between said signal lines, if negative potential of a pulse waveform of said feedback signal cannot be detected.

5. The control system with a diagnostic pulse signal according to claim 1,
wherein said input circuit of said operating terminal and said receiving circuit of said control device are respectively constituted by photocoupler isolating circuits, and said input circuit is constituted by connecting a primary side thereof in series a diode of said photocoupler and a current limiting resistance thereof, one end thereof being connected through said signal line with an output of said variable amplification circuit, while another end thereof is connected through said signal line with an input terminal of said receiving circuit;
said receiving circuit is constituted with a terminal thereof that is connected with an anode of a diode of a photocoupler on a primary side constituting one end of said feedback signal from said input circuit, while a terminal thereof that is connected with ground potential of said photocoupler isolating circuit constitutes another end of a cathode of said diode;
said diagnostic pulse signal generating section is further provided with a signal line changeover switch, connected between an output end of said variable amplifier and an input end of said receiving circuit, that changes over a direction of application of said diagnostic pulse signal in respect of said input circuit by changing over a connection of an output end and an input end to said signal line, and
said internal circuit is arranged so as to conclude “short-circuit is present” between said signal lines, if, on changing over said signal line changeover switch, a same pulse waveform is detected in said feedback signal in both cases.

6. The control system with a diagnostic pulse signal according to claim 1,
wherein said diagnostic pulse signal generating section comprises a variable matching resistance connected in series between an output end of said variable amplification circuit and one end of said signal line; and
an output feedback circuit of said diagnostic pulse signal, in which one end of said signal line is connected as an input end of a variable matching resistance,
wherein said internal circuit, monitors a pulse waveform that is output from said output feedback circuit and is arranged so as to conclude “disconnection is present” if a reflected oscillation wave is present or, otherwise, if distortion is present, to conclude “short-circuit is present”.

7. A control system wherein a diagnostic pulse signal is transmitted through a signal line from a control device to an operating terminal and that diagnoses abnormality of a connection condition from said control device to said operating terminal and a function of said operating terminal,
wherein said control device comprises a diagnostic pulse signal generating section provided with:
(1) an internal circuit, that generates control data that controls said operating terminal with a preset control period and generates diagnostic pulse data for diagnosing said operating terminal with a preset diagnostic period and diagnoses a connection condition from said control device to said operating terminal, based on a waveform of a feedback signal of said diagnostic pulse signal that is fed back from an input end of said operating terminal, and said function of said operating terminal;
(2) a variable amplification circuit provided with:
(a) a non-inverting amplification circuit that generates a control signal based on said control data;
(b) a DA converter that generates a diagnostic pulse signal based on said diagnostic pulse data; and
(c) an adder that multiplexes said diagnostic pulse signal on said control signal and delivers this to said operating terminal at a preset signal level; and
(3) a receiving circuit that receives said feedback signal and delivers this to said internal circuit,
wherein said internal circuit further comprises a correction pulse data generating section that generates correction pulse data that corrects a rise time of said diagnostic pulse signal that is transmitted, and thereby corrects a diagnostic pulse data; and
wherein said rise time of said diagnostic pulse signal is corrected and a diagnostic pulse signal is supplied with reception of said diagnostic pulse signal being made possible by said operating terminal without expanding a pulse width of said diagnostic pulse signal, even when a length of said signal line is long.

8. The control system with a diagnostic pulse signal according to claim 7,
wherein said internal circuit, on receipt of said feedback signal, measures said rise time of said transmitted diagnostic pulse signal and said pulse width;
a correction table is provided in which there are associated beforehand these measured values, a pulse width of said corrected pulse data, and a pulse crest height thereof, and
said diagnostic pulse data is automatically corrected by referencing said correction table, using measured values of said feedback signal.
